(19) United States
(12) Patent Application Publication
(10) Pub. No.: US 2006/0250343 A1
(43) Pub. Date: Nov. 9, 2006

(54) Drive circuit of LCD and method for the same

(76) Inventors: Bily Wang, Hsin Chu City (TW); John Lin, Chiai Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/416,162

(22) Filed: May 3, 2006

(30) Foreign Application Priority Data
May 6, 2005 (TW) 94114760

(51) Int. Cl. G09G 3/36

(52) U.S. Cl. 345/90

(57) ABSTRACT

A drive circuit of display and method for the same are described. Each drive circuit in an LCD panel is sequentially controlled by scanning signals so as to store temporarily a frame of image data in each storage capacitor. Then, a synchronization drive element in each drive circuit receives a synchronization control signal, so that a frame of each storage capacitor may be meanwhile sent to light-emitting units for achievement of the synchronization display on the LCD panel. Besides, a discharge transistor may be added and is controlled by a discharge signal before the synchronization drive element turns ON, which may effectively eliminate a pre-frame on the LCD panel.

### BACKGROUND OF THE INVENTION

1. Field of the Invention

This invention relates to a drive circuit of a liquid crystal display and a method for the same, and particularly to a drive circuit with thin-film transistors as synchronization drive elements and a method for the same.

2. Description of Related Art

FIG. 1 is a schematic view illustrating a conventional liquid crystal display (LCD) panel with thin-film transistors and illustrating an equivalent circuit structured with peripheral drive circuits. As shown in FIG. 1, crisscross data electrodes (Y1, Y2 . . . Ym) and scan electrodes (X1, X2 . . . Xn) are structured on the LCD panel 1, and each group of crisscross data electrode and scan electrode may be used to control a display unit D; for example, a data electrode Y1 and a scan electrode X1 may be used to control a display unit D1. As shown in FIG. 1, each display unit D is controlled with a drive circuit by each crisscross data electrode and scan electrode, and the equivalent circuit of each drive circuit comprises a thin-film transistor Q controlling data input and a storage capacitor C, both of which are connected together.

The gate and drain of thin-film transistor Q are respectively connected to the scan electrode and the data electrode and all the thin-film transistors Q in a row (a scanning line) may be enabled or disabled with a scanning signal on the scan electrode so as to control a video signal on the data electrode for determination of the signal write to the corresponding display unit D.

FIG. 2 are schematic views illustrating a conventional scanning signal control waveform according to FIG. 1. A scan drive unit 12 outputs scanning signals (S1, S2 . . . Sn) to the scan electrodes (X1, X2 . . . Xn) according to a determined scan sequence. When scanning signals are loaded on a certain scan electrode, the thin-film transistors Q in all the drive circuits on a row or a scan electrode keeps ON, the thin-film transistors Q on other rows keep OFF. When a certain scan electrode is selected, a data drive unit 10 sends the corresponding video signal, a gamma value, to m display unit(s) Dm via the data electrode (Y1, Y2 . . . Ym) according to image data to be displayed.

After the scan drive unit 12 goes through a scanning work on n rows of scan lines once, a frame of display is completed. Thus, scanning of all scan electrode (X1, X2 . . . Xn) is repeated, matching the video signal of sent image data, so that display of a continuous image may be achieved.

On the conventional LCD panel 1, a frame of display is completed by way of control of the scanning signals (S1, S2 . . . Sn), but in such a drive control technology, the display of LCD panel is not effectively completed due to the transient state of charge and discharge of the storage capacitors and thin-film transistors Q. As a result, when the crossover of a frame on the LCD panel 1 occurs, remaining images on the display are created, thereby negatively affecting the display quality of LCD panel 1.

### SUMMARY OF THE INVENTION

Accordingly, this invention discloses a drive circuit of a liquid crystal display and method for the same, in which thin-film transistors serve as synchronization drive elements. This invention is a drive circuit in an LCD panel. Each drive circuit in the LCD panel is sequentially controlled by scanning signals and a frame of image data is respectively temporarily stored in each storage capacitor. Then, synchronization drive elements in each synchronization circuit receive a synchronization control signal at the same time. Controlled by the synchronization signal, the synchronization drive elements in each drive circuit send a frame corresponding to each storage capacitor to a light-emitting unit at the same time so as to complete a synchronization display operation on the LCD panel.

In a first embodiment, the drive circuit according to this invention comprises the following elements. A transistor is connected by a gate thereof to a scan electrode to receive scanning signals, and by a drain thereof to a data electrode to receive a data signal. A capacitor is connected by one terminal thereof to the source and another terminal thereof to a ground (GND). A hold capacitor is connected by a terminal thereof to a ground and another terminal thereof to the capacitor through a synchronization drive element controlled by a synchronization control signal. A light-emitting element is connected by a terminal thereof to the hold capacitor, and by another terminal thereof to the ground. The scanning signals control and enable the transistor so that the data signal may be temporarily stored in the capacitor. After the synchronization drive element is enabled, the data signal is transmitted to the hold capacitor through the synchronization drive element to drive the light-emitting element.

In a second embodiment, the drive circuit according to this invention is further connected to a discharge transistor. The drain of the discharge transistor is connected to the synchronization drive element, the source of the discharge transistor is connected to ground, and the gate of the discharge transistor is connected to a discharge circuit outputting a discharge signal, before the synchronization drive element is enabled, in order to control the discharge transistor.

Thus, after being controlled by the scanning signals, the drive circuit according to this invention is controlled by the synchronization control signal so that each synchronization drive element in the drive circuit may send a frame of data stored in each storage capacitor to the light-emitting unit for achievement of the synchronization display on the LCD panel.

What is summarized above and will be described in detail are exemplary for claims of this invention. Other objects and advantages of this invention will be described accompanying figures.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view illustrating a conventional liquid crystal display panel with thin-film transistors and illustrating an equivalent circuit structured with peripheral drive circuits;

FIG. 2 is a schematic view illustrating a conventional scanning signal control waveform;

FIG. 3 is a schematic view illustrating an equivalent circuit in a first embodiment of this invention used in an LCD panel and a peripheral drive circuit thereof;

FIG. 4 is a schematic view illustrating the drive circuit in the first embodiment of this invention;

FIG. 5 is a schematic view illustrating a periodic waveform of scanning signal and synchronization control signal in the first embodiment of this invention;

FIG. 6 is a schematic view illustrating an equivalent circuit in a second embodiment of this invention used in the LCD panel and its peripheral drive circuit;

FIG. 7 is a schematic view illustrating the drive circuit in the second embodiment of this invention; and

FIG. 8 is a schematic view illustrating a periodic waveform of scanning signal and synchronization control signal in the second embodiment of this invention.

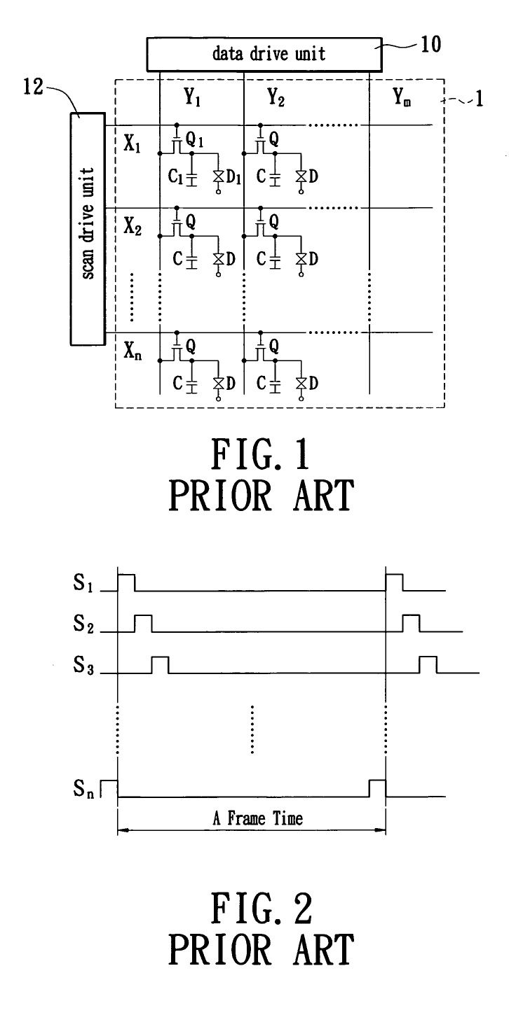

### DETAILED DESCRIPTION OF THE PREFERRED EMBODIMENTS

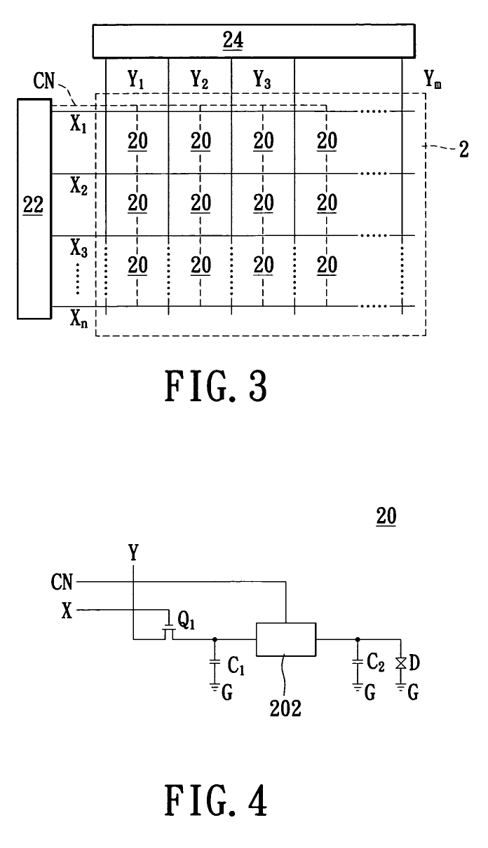

FIG. 3 is a schematic view illustrating an equivalent circuit in a first embodiment of this invention used in an LCD panel and a peripheral drive circuit thereof. As shown in FIG. 3, this invention is used on the LCD panel 2. Crisscross data electrodes (Y1, Y2 . . . Ym) and scan electrodes (X1, X2 . . . Xn) are structured on the LCD panel. The data electrode (Y1, Y2 . . . Ym) corresponds to the output of a data drive unit 24, while the scan electrode (X1, X2 . . . Xn) corresponds to the output of a scan drive unit 22. Each group of crisscross data electrode and scan electrode controls each display unit 20 according to the output of scan drive unit 22 and the output of data drive unit 24.

FIG. 4 is a schematic view illustrating a drive circuit in the first embodiment of this invention according to FIG. 3. In each display unit 20 of the LCD panel 2, the drive circuit in the first embodiment of this invention is used to drive a light-emitting element D, and the light-emitting element D is a light-emitting diode (LED). The drive circuit according to this invention comprises a transistor Q1 as a thin-film transistor (TFT) Q1 of which the gate is connected to the output of scan drive unit 22 through a scan electrode X to receive a scan signal, the drain is connected to the output of data drive unit 24 through a data electrode Y to receive a data signal, and the source is connected to a terminal of a capacitor C1, of which the other terminal is connected to ground (G).

The drive circuit according to this invention further comprises a hold capacitor C2, of which a terminal is connected to ground (G), and another terminal is connected to one of the terminals of capacitor C1 through a synchronization drive element 202. The synchronization drive element 202 is a thin-film transistor, of which a control terminal is connected to the output of scan drive unit 22, and controlled by a synchronization control signal CN. A terminal of the light-emitting element D is connected to the hold capacitor C2, and the other terminal of the element D is connected to a ground (G). A scanning signal output by the scan drive unit 22 is used to control and enable the transistor Q1 so that a data signal output by the data drive unit 24 may be temporarily stored in the capacitor C1, and after the synchronization control signal CN output by the scan drive unit 22 controls and enables the synchronization drive element 202, the data signal temporarily stored in the capacitor C1 is sent to the hold capacitor C2 through the synchronization element 202 to drive the light-emitting element D.

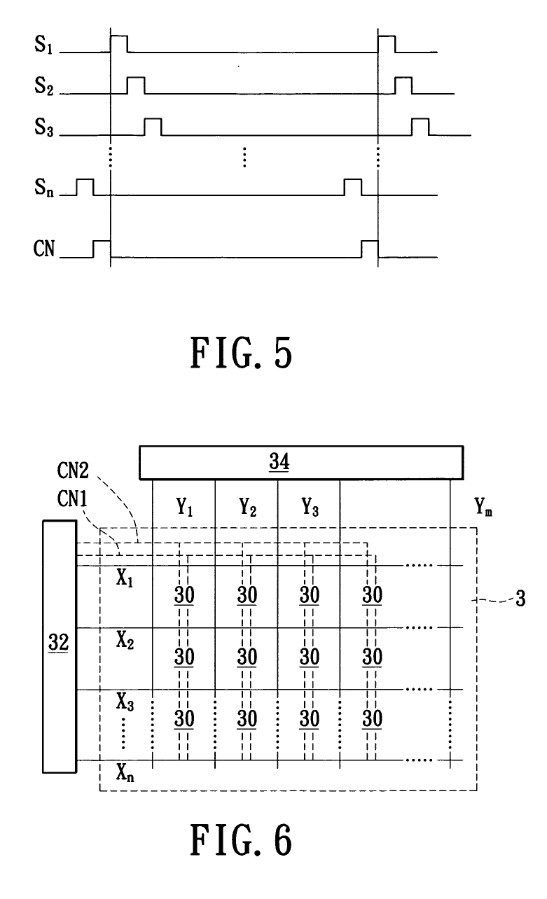

FIG. 5 is a schematic view illustrating a periodic waveform of scanning signal and synchronization control signal in the first embodiment of this invention according to FIGS. 3 and 4. As shown in FIG. 5, the scanning signals (S1, S2 . . . Sn) are periodically sent from the scan drive unit 22 to each display unit 20 in a determined scan sequence through the scan electrodes (X1, X2 . . . Xn) of the LCD panel 2. After each period of scanning signals (S1, S2 . . . Sn), the scan drive unit 22 also sends a synchronization control signal CN, and the synchronization control signal CN is sent to each display unit 20 for achievement of the synchronization display on the LCD panel 2.

Further referring now to FIGS. 3, 4, and 5, when a certain scan electrode (X1, X2 . . . Xn) on the LCD panel 2 receives a scanning signal, the transistors Q1 in all the display unit 20 on a row or on a scan electrode turn ON, while the transistors Q1 on other rows turn OFF. Again, when the transistors Q1 in all the display unit 20 on a row or on a scan electrode turn ON, the data signal output by the data drive unit 24 is temporarily stored in the capacitors C1 in all the display units 20 on a row or on a scan electrode.

Next, the scanning signals (S1, S2 . . . Sn) sent from the scan drive unit 22 are periodically sent to all the display units 20 on a row or on a scan electrode of the LCD panel 2 in a determined scan sequence through the scan electrode (X1, X2 . . . Xn) of the LCD panel 2 to store temporarily the data signal output by the data drive unit 24 in the capacitors Cl in all the display units 20 on the LCD panel 2. Here, a frame of image data is shown.

As described above, after outputting a period of scanning signals (S1, S2 . . . Sn), the scan drive unit 22 further outputs a synchronization control signal CN to the synchronization drive element 202 in all the display units 20 on the LCD panel 2 to control and enable the synchronization drive elements 202 (ON). After the synchronization drive element 202 in all the display units 20 on the LCD panel 2 is enabled (ON), a frame of the image data temporarily stored in the capacitors C1 is sent to the hold capacitors C2 through the synchronization drive elements 202 to drive the light-emitting elements D for achievement of the synchronization display on the LCD panel.

Next, FIG. 6 is a schematic view illustrating an equivalent circuit in a second embodiment of this invention used in the LCD panel and its peripheral drive circuit. The second embodiment is different from the first embodiment mainly in the output signal of a scan drive unit 32 and the drive circuit of a display unit 30. In the second embodiment, the signal output by the scan drive unit 32 is further provided with a discharge signal CN2. Referring now to FIG. 8, the discharge signal CN2 is generated after the period of scanning signals (S1, S2 . . . Sn) and then the scan drive unit 32 outputs a synchronization control signal CN1. Thus, in the second embodiment of this invention, the scanning signals (S1, S2 . . . Sn), the discharge signal CN2, and the synchronization control signal CN1 are sequentially generated by the scan drive unit 32.

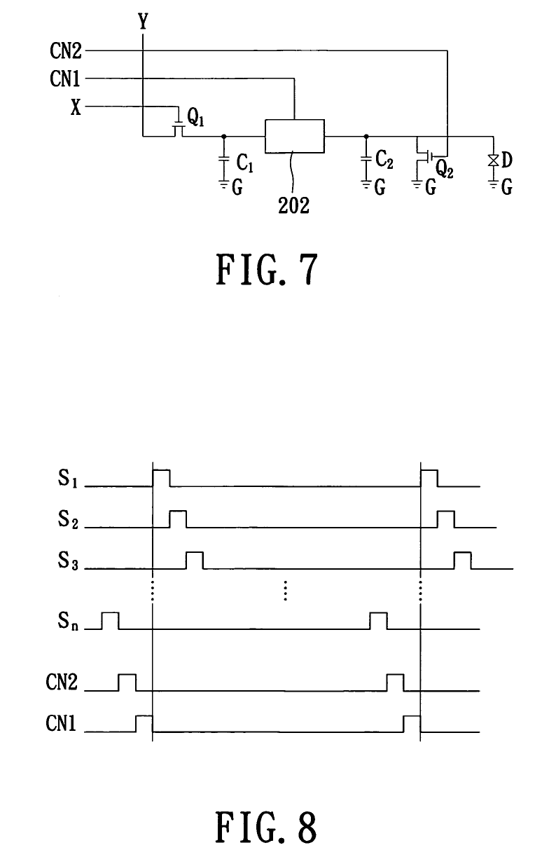

FIG. 7 is a schematic view illustrating the drive circuit in the second embodiment of this invention according to FIG. 6. In each display unit 30 of the LCD panel 3, the drive circuit in the second embodiment of this invention is used to drive a light-emitting element D, and the light-emitting element D is a light-emitting diode (LED). Compared with the drive circuit in the first embodiment, the drive circuit in the second embodiment of this invention further comprises a discharge transistor Q2 as a thin-film transistor (TFT). The drain of discharge transistor Q2 is connected to the synchronization drive element 202 and the hold capacitor C2, the source of transistor Q2 is connected to ground G, and the gate of transistor Q2 is connected to the output of scan drive unit 32 through a discharge circuit (not shown). The discharge transistor Q2 is controlled by the discharge signal CN2 output by the scan drive unit 32 and turns ON, before the synchronization drive element 202 is enabled, so as to charge and discharge the signal stored in the hold capacitor C2.

In the drive circuit in the second embodiment, the discharge signal CN2 and the synchronization control signal CN1 of the periodic signals are sequentially output by the scan drive unit 32, and after the synchronization drive element 202 is controlled by the synchronization control signal CN1 and then turns ON, the data signal temporarily stored in the capacitor C1 is sent to the hold capacitor C2 through the synchronization drive element 202 to drive the light-emitting element D.

Further referring now to FIGS. 6, 7, and 8, when a certain scan electrode (X1, X2 . . . Xn) on the LCD panel 3 receives a scanning signal, the transistors Q1 in all the display unit 30 on a row or on a scan electrode turn ON, while the transistors Q1 on other rows turn OFF. Again, when the transistors Q1 in all the display unit 30 on a row or on a scan electrode turn ON, the data signal output by the data drive unit 34 is temporarily stored in the capacitors C1 in all the display units 30 on a row or on a scan electrode.

Next, the scanning signals (S1, S2 . . . Sn) sent from the scan drive unit 32 are periodically sent to all the display units 30 on a row or on a scan electrode of the LCD panel 3 in a determined scan sequence through the scan electrode (X1, X2 . . . Xn) of the LCD panel 3 to store temporarily the data signal output by the data drive unit 34 in the capacitors C1 in all the display units 30 on the LCD panel 3. Here, a frame of image data is shown.

As described above, after outputting a period of scanning signals (S1, S2 . . . Sn), the scan drive unit 32 further outputs a discharge signal CN2 to the discharge transistors Q2 in all the display units 30 on the LCD panel 3 to control and enable the discharge transistor Q2 (ON) so that the discharge transistors Q2 discharge the signals stored in the hold capacitor C2 in all the display units 30. Next, after outputting the discharge signal CN2, the scan drive unit 32 further outputs a synchronization control signal CN1 to the synchronization drive element 202 in all the display units 30 on the LCD panel 3 to control and enable the synchronization drive elements 202 (ON). After the synchronization drive element 202 in all the display units 30 on the LCD panel 3 is enabled (ON), a frame of image data temporarily stored in the capacitors C1 is sent to the discharged hold capacitors C2 through the synchronization drive elements 202 to drive the light-emitting elements D for achievement of the synchronization display on the LCD panel 3.

To sum up, the drive circuit of display according to this invention is located in the LCD panel, in which each drive circuit is sequentially controlled by the scanning signal so as to store temporarily a frame of image data in each storage capacitor. Then, the synchronization drive element in each drive circuit simultaneously receives a synchronization control signal so that a frame of each storage capacitor may be meanwhile sent to the light-emitting unit for achievement of the synchronization display on the LCD panel. Besides, a discharge transistor may be added and is controlled by a discharge signal before the synchronization drive element turns ON, which may effectively eliminate a pre-frame on the LCD panel.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A drive circuit of liquid crystal display, used to drive a light-emitting element, comprising:
a transistor having a drain, a gate, and a source, wherein the gate is connected to a scan electrode to receive a scanning signal and the drain is connected to a data electrode to receive a data signal;
a capacitor having two terminal, wherein one terminal is connected to the source and another terminal is connected to a ground;
a synchronization drive element connected to a terminal of the capacitor and controlled by a control signal; and
a hold capacitor having two terminals, wherein one terminal is connected to ground and another terminal is connected to the synchronization drive element and-the light-emitting element;
wherein the scanning signal controls and enables the transistor to store temporarily the data signal in the capacitor, and after the synchronization drive element is enabled, the data signal is transmitted to the hold capacitor through the synchronization drive element to drive the light-emitting element.

2. The drive circuit according to claim 1, wherein the light-emitting element is a light-emitting diode.

3. The drive circuit according to claim 1, wherein the transistor is a thin-film transistor.

4. The drive circuit according to claim 1, wherein the synchronization drive element is a thin-film transistor.

5. The drive circuit according to claim 1, wherein the circuit further comprises a discharge transistor, wherein a drain of the discharge transistor is connected to the synchronization drive element, a source of the discharge transistor is connected to a ground, and a gate of the discharge transistor is connected to a discharge circuit outputting a discharge signal, before the synchronization drive element is enabled, in order to control the discharge transistor.

6. The drive circuit according to claim 1, wherein the discharge transistor is a thin-film transistor.

7. A method of driving a liquid crystal display having a plurality of display units, comprising steps of:
sending a period of scanning signals to transistors in each display unit and turning the transistors ON;
storing a frame of data signal in capacitors in each display unit according to enabled transistors; and
synchronously sending a frame of data stored in the capacitors to light-emitting elements in each display unit.

8. The method according to claim 7, wherein at the step of synchronous transfer, a frame of data is temporarily stored in a hold capacitor of each display unit for use in the light-emitting elements.

9. The method according to claim 8, wherein before the step of synchronous transfer, a step of discharge is further included to discharge in advance hold capacitors in each display unit.
